(19) United States
(12) Patent Application Publication
(10) Pub. No.: US 2017/0349220 A1
(43) Pub. Date: Dec. 7, 2017

(54) DIFFERENT MATERIAL JOINING STRUCTURE AND DIFFERENT MATERIAL JOINING METHOD

(71) Applicant: HONDA MOTOR CO., LTD., MINATO-KU, TOKYO (JP)

(72) Inventors: Takayuki YAMADA, WAKO-SHI, SAITAMA (JP); Yasumasa HYODO, WAKO-SHI, SAITAMA (JP)

(21) Appl. No.: 15/539,367

(22) PCT Filed: Dec. 25, 2014
(86) PCT No.: PCT/JP2014/084221

§ 371 Date: Jun. 23, 2017

(51) Int. Cl. B62D 27/02; B62D 29/00; B62D 25/06; F16B 19/04; B21J 15/02

(52) U.S. Cl. CPC B62D 27/023; F16B 19/04; B21J 15/02; B62D 25/06; B62D 29/00

(57) ABSTRACT

A different material joining structure has: a first panel made of a first metal material; a second panel made of a second metal material that has a higher conductivity than that of the first panel, is different from the first metal material, and at least a part of which faces the first panel; and a rivet for joining the first panel and the second panel, wherein the rivet is made of the first material, and includes a head portion that is embedded in the second panel in a non-penetrating manner and a bottom portion that abuts on the first panel, and wherein a nugget portion as a joint portion is disposed between the first panel and the bottom portion, the nugget portion being formed by resistance welding the rivet to the first portion with the rivet disposed between the first panel and the second panel.

### TECHNICAL FIELD

The present invention relates to a different material joining structure and a different material joining method for joining different kinds of metals.

### BACKGROUND ART

For example, Patent Document 1 discloses, as shown in FIG. 8A, that a rivet 4 is used to join a joint face of an aluminum roof panel 1 to a joint face of a side roof rail 2 made of steel. A structural adhesive 3 having an electric insulating property is pasted between the joint faces of the aluminum roof panel 1 and the steel side roof rail 2.

Further, Patent Document 2 discloses, as shown in FIG. 8B, that, a rivet 6 for joining different materials is made to penetrate a steel panel 5 to join, and then, the rivet 6 for joining different materials is spot-welded on a panel 7 made of an aluminum alloy material, to join the panels 5, 7 made of different materials together.

### PRIOR ART DOCUMENT

### Patent Document

Patent Document 1: Japanese Patent Application Publication No. 2005-119577

Patent Document 2: Japanese Patent Application Publication No. 2010-207898

### SUMMARY OF THE INVENTION

### Problems to be Solved by the Invention

However, in the joining structure disclosed in Patent Document 1, when the aluminum roof panel 1 is joined to the steel side roof rail 2, the rivet 4 needs to penetrate the aluminum roof panel 1 and the side roof rail 2. In recent years, iron members are made to have higher strength in accordance with the increasing demand for weight reduction, causing the rivet 4 to have difficulty in penetrating the iron members. Consequently, it becomes difficult to join the aluminum roof panel 1 to the side roof rail 2 by the rivet 4. Specifically, for example, it is difficult for the rivet to penetrate through high-strength iron materials having tensile strength of 980 MPa or more.

Further, in the joining structure disclosed in Patent Document 1, on a vehicle body assembly line, separate steps are needed for applying the structural adhesive 3 and for welding the rivet 4, respectively. Therefore, as compared with an assembly step using conventional spot welding, assembly time increases and manufacturing cost soars due to additional new facility investment (for example, a structural adhesive coating device).

Still further, in the joining structure disclosed in Patent Document 2, the steel panel 5 needs drilling a prepared hole through which the rivet for joining different materials penetrates. This lowers production efficiency and water may leak through the prepared hole, or the water and moisture may pass through the prepared hole, to form rust on the contact faces between the rivet for joining different materials and the panel 7 made of an aluminum alloy material.

The purpose of the present invention is to provide a different material joining structure and a different material joining method which can be used in accordance with iron members having a high strength and requires no drilling for a prepared hole.

### Means for Solving the Problems

To solve the above problems, the present invention provides a different material joining structure having: a first panel made of a first metal material; a second panel made of a second metal material that has a higher conductivity than that of the first panel, is different from the first metal material, and at least a part of which faces the first panel; and a rivet for joining the first panel and the second panel, wherein the rivet is made of the first material, and includes a head portion that is embedded in the second panel in a non-penetrating manner and a bottom portion that abuts on the first panel, and wherein a nugget portion as a joint portion is disposed between the first panel and the bottom portion, the nugget portion being formed by resistance welding the rivet to the first portion with the rivet disposed between the first panel and the second panel.

According to the present invention, the head portion of the rivet is embedded in the second panel (for example, by mechanical fastening such as calking) in a non-penetrating manner in advance. Then, the second panel, the rivet and the first panel are overlaid from top down in that order between a pair of electrodes used for resistance welding, and the pair of electrodes is energized in a state that the rivet is disposed between the second panel and the first panel for resistance welding. At that time, the second panel has a higher electrical conductivity than that of the first panel, to make an electric resistance the highest between the rivet and first panel having a low electrical conductivity, so as to generate heat to form the nugget portion as the joint portion. Therefore, the present invention allows the rivet which is mechanically fastened to the second panel to firmly join to the first panel made of the same kind of metal material as the rivet by resistance welding. Consequently, in the present invention, the first panel is firmly joined to the second panel via the rivet.

In the present invention, the rivet does not need to penetrate as the prior art disclosed in Patent Document 1, and can be used, for example, with the first panel made of a high strength material, specifically, a high strength material made of iron having a tensile strength of 980 MPa or more.

Further, in the present invention, the rivet is mechanically fastened to the second panel and a through hole (prepared hole) is not formed in the second panel, because the through hole (prepared hole) is unnecessary. Accordingly, in the present invention, water does not enter through a prepared hole so that galvanic corrosion (electrochemical corrosion) can be prevented even without a separate sealing material. This reduces the manufacturing cost.

Still further, in the present invention, the rivet can be mechanically fastened to the second panel in advance, on a line separate from the vehicle body assembly line. Accordingly, the rivet only has to be resistance welded to the first panel on the vehicle body assembly line, which increases productivity and requires no new facility investment (for example, a structural adhesive coating device), so that the cost associated with facility investment is avoided.

Further, in the present invention, the rivet includes a locking portion that, before the head portion is embedded in the second panel, protrudes in an axial direction from an peripheral edge of the head portion, and then is pressed to the second panel to spread in a direction orthogonal to an axial direction so as to be locked in the second panel, and, after the head portion is embedded in the second panel, the locking portion is made flush with the head portion.

According to the present invention, in the initial state where the rivet is not embedded in the second panel, the rivet includes the locking portion protruding in the axial direction from the peripheral edge of the head portion. In the state where the rivet is pressed to fasten the second panel, the locking portion is deformed to spread in the direction orthogonal to the axial direction, to form a flat face by the head portion and the locking portion. The joined face of the second panel which faces the flat face formed by the head portion and the locking portion is also made flat. As a result, in the present embodiment, the current during resistance welding stably flows through the nugget portion as a joint portion, allowing for forming the nugget portion stably. In other words, the fastened faces (joined faces) of the rivet and the second panel are made flat, respectively, to form a stable power supply path from the electrodes during resistance welding, so that welding defects are avoided to secure the stable nugget portion.

Still further, in the present invention, before the head portion is embedded in the second panel, the locking portion includes: a first side that extends from an outer peripheral face of a shaft arranged between the head portion and the bottom portion in an axial direction, and a second side that extends radially to incline downward from an extended end of the first side toward the head portion in the axial direction, and the locking portion is formed in a substantially triangular shape in cross-section by the first side, the second side and a boundary line between the locking portion and the head portion.

According to the present invention, the locking portion is formed in a substantially triangular shape in cross-section by the first side, the second side and the boundary line. When the rivet is pressed to join to the second panel, the locking portion is deformed to spread in the direction orthogonal to the axial direction, to form the flat face by the head portion and the locking portion.

Yet further, in the present invention, after the locking portion is joined to the second panel, respective contact faces of the second panel and the locking portion are made flat.

According to the present invention, the contact faces of the locking portion of the rivet and the second panel are made flat, respectively, to form a stable power supply path from the electrodes during resistance welding, so that welding defects are avoided to secure the stable nugget portion.

Yet further, in the present invention, the second panel includes an annular protrusion formed by pressing the rivet to the second panel, and, after the locking portion is embedded in the second panel, the minimum inner diameter of the protrusion is set to be smaller than the maximum outer diameter of the locking portion.

According to the present invention, the minimum inner diameter (D1) of the protrusion is set to be smaller than the maximum outer diameter (D2) of the locking portion (D1<D2), to allow for deforming the locking portion outward while spreading it so as to join (fasten) the rivet stably to the second panel.

Yet further, in the present invention, the first panel includes plate members and an outer diameter of the bottom portion is set to be larger than an outer diameter of the shaft.

According to the present invention, the bottom portion constituting the rivet has a larger diameter than the shaft, to allow for enlarging a contact area between the bottom portion of the rivet and the first panel at the time of resistance welding, as compared with a case of the bottom portion having the same diameter as the shaft. Accordingly, current density flowing during resistance welding is decreased to allow heat to be generated at a position closer to a boundary or boundaries between the plate members constituting the first panel. As a result, the rivet and the plate members constituting the first panel are joined simultaneously.

Yet further, in the present invention, the resistance welding is spot welding.

Spot welding needs a relatively short time (takt) for welding among several kinds of resistance welding and has a high welding stability, and therefore, according to the present invention, productivity is improved. Further, spot welding has been used conventionally on the common vehicle body assembly line, so that a new welding facility is not necessary and a new facility investment is avoided.

Yet further, in the present invention, plating is applied on an external face of the first panel.

According to the present invention, plating is applied on the external face of the first panel to achieve antirust effect of the steel plates constituting the first panel. If the rivet is made to penetrate the steel plates as in the prior art, the plated layer may be peeled off, which needs to be repaired, to reduce productivity. In the present embodiment, the plated layer formed on the external face suffers under little influence from the rivet, allowing for improving productivity.

Yet further, in the present invention, plating is applied on an external face of the rivet.

According to the present invention, plating is applied on the external face of the rivet to prevent galvanic corrosion (electrochemical corrosion), that is, rusting between the second panel and the rivet which are formed of different kinds of metals. Further, the rivet is made of the first panel, to prevent deterioration of rust-prevention property due to contact between different kinds of metals.

Yet further, in the present invention, a vehicle includes: a pair of right and left roof side rails that extends in a longitudinal direction of the vehicle at upper vehicle body sides; and a pair of right and left side outer panels that covers vehicle outer sides of the respective roof side rails to form design faces of the vehicle body sides, wherein the first panel is formed of each roof side rail, and the second panel is formed of each side outer panel.

According to the present invention, the side outer panel which is a larger-sized part than other body parts can be made of aluminum, aluminum-magnesium alloy, or the like having a higher conductivity than that of iron, leading to weight reduction of the vehicle body. Further, the roof side rails as vehicle body frame members can be formed of a high-tensile steel plate, leading to a high strength and a weight reduction of the vehicle body.

According to a different material joining method of the present invention, a head portion of a rivet is embedded in a second panel in a non-penetrating manner in advance by, a mechanical fastening method such as calking. Then, a bottom portion of the rivet is abutted on a face of the first panel that faces the second panel. While the abutting state is kept, resistance welding is performed in a state that the rivet is disposed between the first panel and the second panel, so that a nugget portion is formed between the first panel and the bottom portion. As a result, in the different material joining method of the present invention, the first panel is firmly joined to the second panel via the rivet.

### Effect of the Invention

The present invention provides a different material joining structure and a different material joining method which can be used in accordance with iron members having a high strength and requires no drilling for a prepared hole.

### BRIEF DESCRIPTION OF THE DRAWINGS

FIG. 1A is a side view of a vehicle body side of a vehicle having a different material joining structure according to an embodiment of the present invention; FIG. 1B is an end view taken along a line II-II in FIG. 1A;

FIG. 2 is a partially enlarged end view of an A-portion as a first joint portion in FIG. 1B;

FIG. 3A is a perspective view of a rivet in an initial shape; FIG. 3B is a cross-sectional view taken along a line in FIG. 3A;

FIGS. 4A to 4C are cross-sectional views of a fastening step in which a head portion of the rivet is calked so as to fasten the rivet to an side outer panel;

FIGS. 5A to 5C are views of steps of a different material joining method according to the present embodiment;

FIG. 6A is an explanatory view of a rivet of a comparative example being spot-welded in which a diameter of a shaft is the same as that of a bottom portion; FIG. 6B is an explanatory view of a rivet according to the present embodiment being spot-welded in which a diameter of the bottom portion is larger than that of the shaft;

FIG. 7A is an explanatory view of a case in which plating is applied on an external face of the rivet; FIG.7B is an explanatory view of a case in which plating is applied on an external face of a roof side rail; FIG. 7C is an explanatory view of a case in which plating is applied on both external faces of the rivet and the roof side rail; and

FIGS. 8A and 8B are cross-sectional views of respective joining structures according to a prior art.

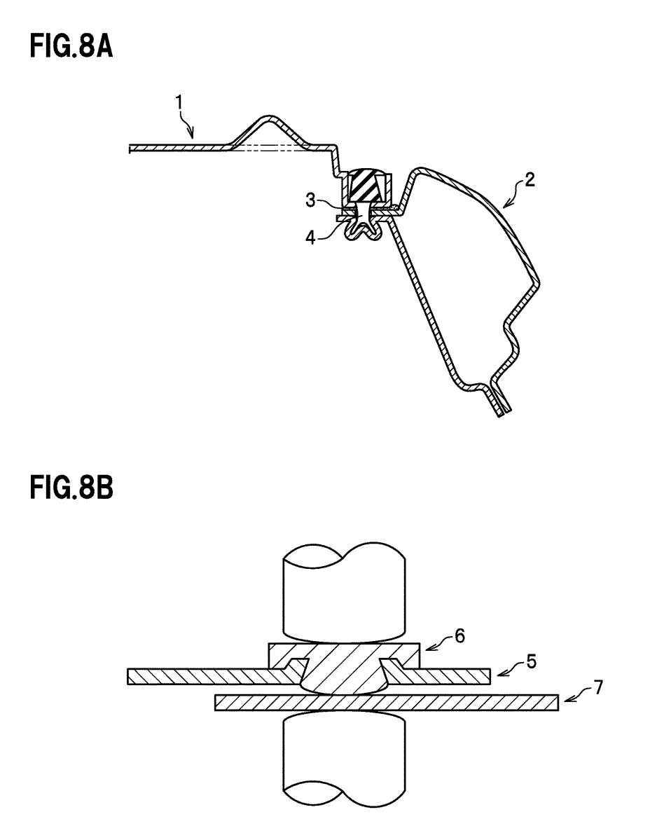

### EMBODIMENTS FOR CARRYING OUT THE INVENTION

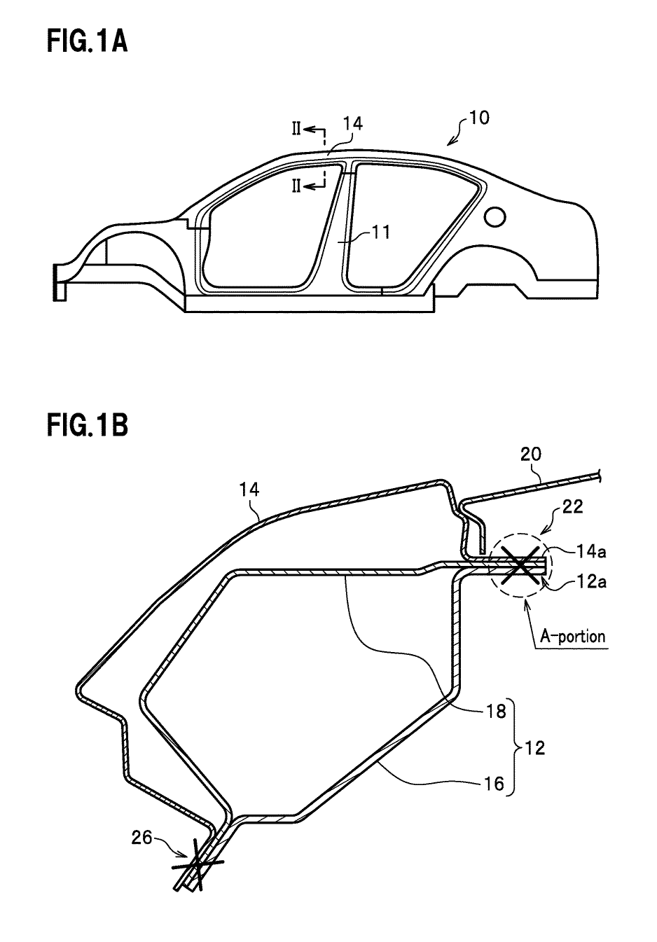

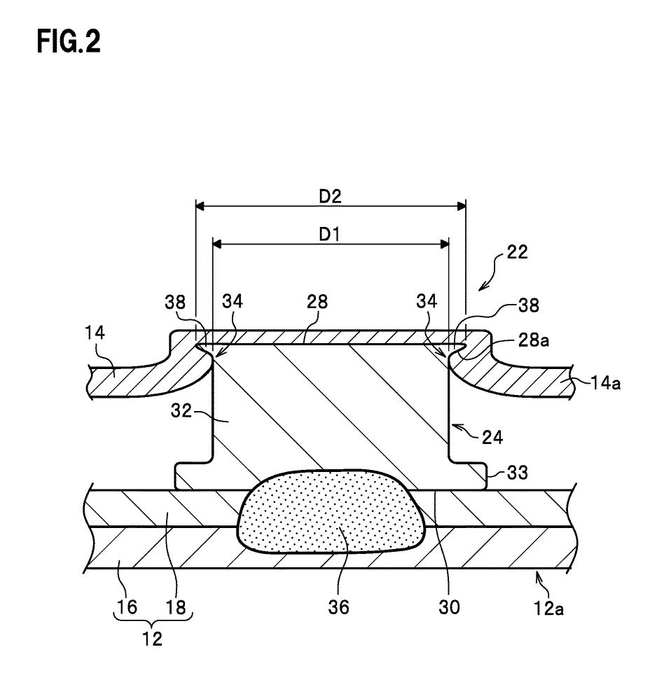

Next, a description will be given of an embodiment of the present invention with reference to the accompanying drawings appropriately. FIG. 1A is a side view of a vehicle body side of a vehicle having a different material joining structure according to the embodiment of the present invention, FIG. 1B is an end view taken along a line II-II in FIG. 1A, and FIG. 2 is a partially enlarged end view of an A-portion as a first joint portion in FIG. 1B.

As shown in FIGS. 1A and 1B, a vehicle 10 includes a pair of right and left roof side rails 12, 12 which is supported by a pair of right and left center pillars 11, 11 and extends in a longitudinal direction of the vehicle 10 at upper vehicle body sides, and a pair of right and left side outer panels 14, 14 which covers vehicle outer sides of the respective roof side rails 12 to form design faces of the vehicle body sides.

Note that FIGS. 1A and 1B only show the roof side rail 12 and the side outer panel 14 on the left side and do not show them on the right side.

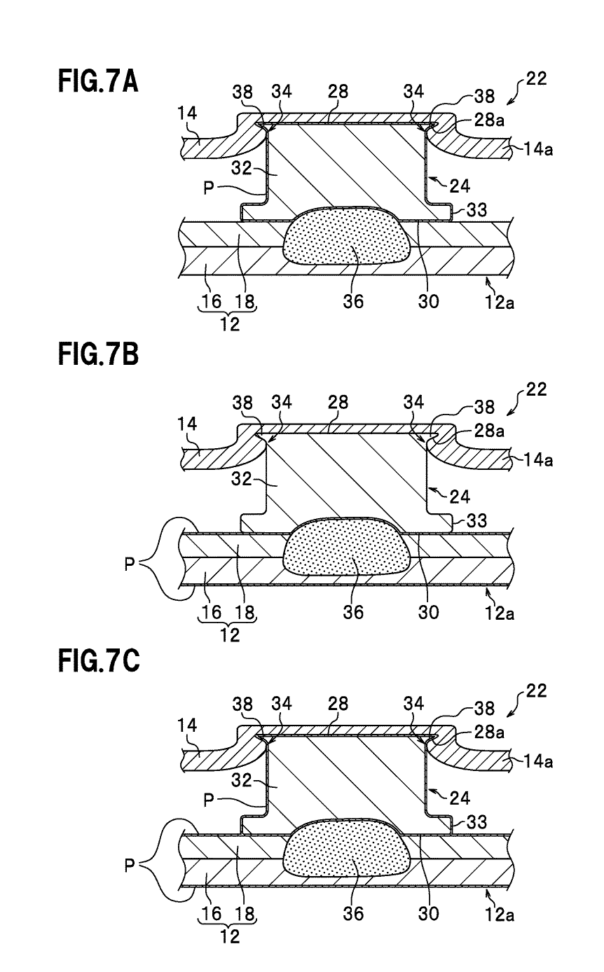

The roof side rail 12 is made of a metal material such as steel in a hollow shape to serve as a “first panel”. Note that plating with zinc or the like is preferably applied on an an external face of the roof side rail 12 (see FIGS. 7B and 7C to be described later).

Each roof side rail 12 includes plate members which are overlaid along an upper/lower direction of the vehicle or in a substantially vertical direction, one of which being a side rail inner 16 arranged inside a vehicle compartment, the other of which being a side rail stiffener 18 positioned between the side rail inner 16 and the side outer panel 14 and arranged more outside the vehicle compartment than the side rail inner 16.

Each side outer panel 14 is made of, for example, aluminum or an aluminum-magnesium alloy and is formed of a different metal material having a higher conductivity than the roof side rail 12, to serve as a “second panel”.

A roof panel 20 is arranged at an upper portion of the vehicle 10 which extends in the longitudinal direction of the vehicle 10 so as to be joined to, and supported by, the pair of right and left roof side rails 12, 12.

As shown in FIG. 1B, a first joint portion 22 is arranged between an inner end 14a in the vehicle width direction of the side outer panel 14 located on an upper side and an inner end 12a in the vehicle width direction of the roof side rail 12 located on a lower side. A rivet (rivet for joining different materials) 24 (see FIG. 2) is disposed in the first joint portion 22 for joining the side outer panel 14 to the roof side rail 12.

A second joint portion 26 is arranged between an outer end in the vehicle width direction of the side outer panel 14 and an outer end 12b in the vehicle width direction of the roof side rail 12. Another rivet 24 is disposed in the second joint portion 26 for joining the side outer panel 14 to the roof side rail 12.

In the first joint portion 22 and the second joint portion 26, the respective rivets 24 have the same shape. Note that, in the first joint portion 22 and the second joint portion 26, the three plates which are the side outer panel 14, the side rail stiffener 18 and the side rail inner 16 are, from top down, overlaid so as to be joined in one piece.

The rivet 24 is made of the same metal material such as iron as the roof side rail 12 which serves as a first panel. Further, as shown in FIGS. 7A and 7C to be described later, plating is preferably applied on an external face of the rivet 24.

As shown in FIG. 2, the rivet 24 formed to have a substantially cylindrical shape generally in a state of the roof side rail 12 being joined to the side outer panel 14. The rivet 24 includes a head portion 28 positioned on the upper side, a bottom portion 30 positioned on the lower side, and a shaft 32 arranged between the head portion 28 and the bottom portion 30.

In the joining state, the outer diameter of the head portion 28 positioned on the upper side of the rivet 24 is set larger than that of the shaft 32 positioned under the head portion 28. Further, an annular flange 33 is formed at the bottom portion 30 so as to be continuous to the shaft 32 and to extend radially outward from the outer peripheral face at the lower end of the shaft 32. The outer diameter of the annular flange 33 is set larger than those of the head portion 28 and the shaft 32.

The side outer panel 14 includes an annular protrusion 34 which is formed, as described later, by pressing the rivet 24 toward the side outer panel 14 in a state that the head portion 28 of the rivet 24 is in contact with a face of the side outer panel 14 which faces the roof side rail 12. The protrusion 34 is formed by an annular expanded portion which expands radially inward (toward the rivet 24). The annular expanded portion is formed to have a chevron shape in cross-section. The annular expanded portion surrounds the upper side of the outer peripheral face of the shaft 32 at a skirt 28a on the outer periphery of the head portion 28 and the boundary portion between the head portion 28 and the shaft 32.

The head portion 28 of the rivet 24 is calked in a non-penetrating manner to join a face of the side outer panel 14 which faces the roof side rail 12. A nugget portion 36 as a joint portion is formed between the side outer panel 14 and the bottom portion 30 of the rivet 24 by spot-welding, as described later, in a state that the rivet 24 is disposed between the side outer panel 14 and the roof side rail 12. The rivet 24 is firmly fixed to the roof side rail 12 by the nugget portion 36.

Here, the initial shape of the rivet 24 will be described, in a state that the side outer panel 14 is not joined to the roof side rail 12 and the rivet 24 is not calked to the side outer panel 14.

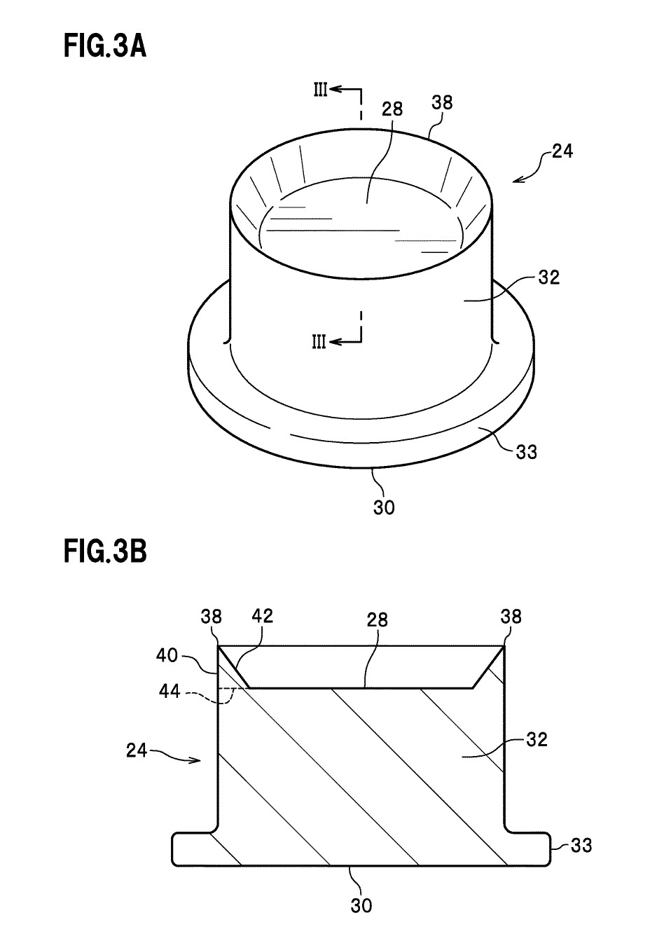

FIG. 3A is a perspective view of the rivet in the initial shape, and FIG. 3B is a cross-sectional view taken along a line III-III in FIG. 3A.

As shown in FIG. 3A, in the initial shape, the rivet 24 basically includes the head portion 28 at the upper side, the bottom portion 30 at the lower side and the shaft 32 arranged between the head portion 28 and the bottom portion 30. Further, the rivet 24 includes an annular locking portion 38 which protrudes upward in the axial direction from the peripheral edge of the head portion 28.

The locking portion 38, in the cross-sectional shape shown in FIG. 3B, includes a first side 40 which extends upward in the axial direction of the shaft 32 from the outer peripheral face of the shaft 32 arranged between the head portion 28 and the bottom portion 30, and a second side 42 which extends radially to incline downward (slopes downward) toward the head portion 28 from the extended end (upper end) of the first side 40. In this case, the locking portion 38 is formed in a substantially triangular shape having acute angles in cross-section by the first side 40, the second side 42 and a boundary line 44 which forms the boundary between the locking portion 38 and the head portion 28.

The locking portion 38 is pressed to the side outer panel 14 so as to be calked, and then, spreads in the direction orthogonal to the axial direction (radially outward) to be locked by the protrusion 34 of the side outer panel 14.

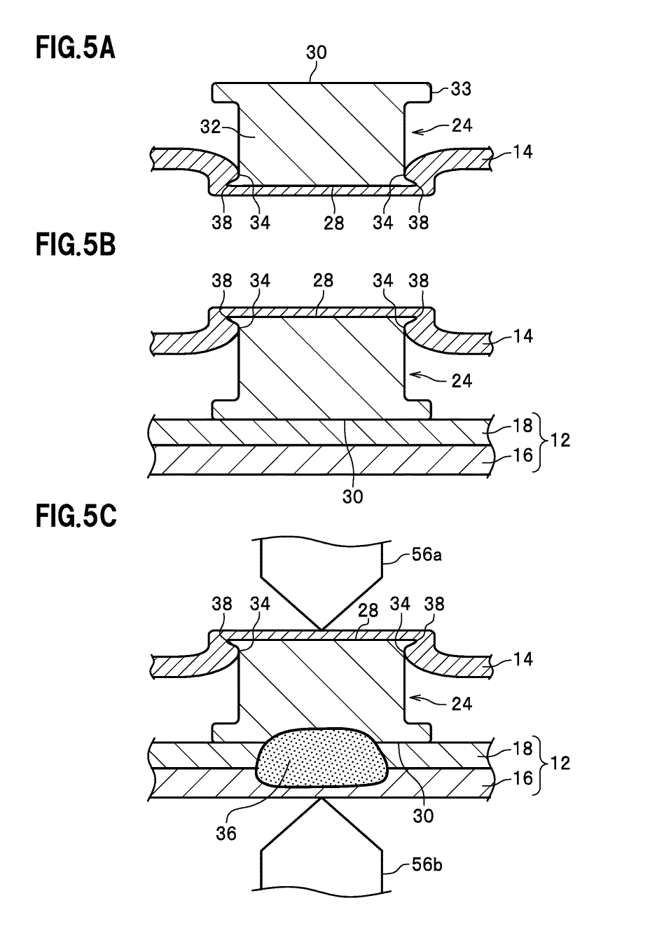

Further, after the locking portion 38 is pressed to be calked in the side outer panel 14, respective contact faces of the side outer panel 14 and the locking portion 38 are made flat (see FIG. 5A to be described later). Thus, after the head portion 28 is calked to join the side outer panel 14, the locking portion 38 is formed to be flush with the face of the head portion 28.

As shown in FIG. 2, after the rivet 24 is calked and joined to the side outer panel 14, the minimum inner diameter D1 of the protrusion 34 surrounding the outer periphery of the locking portion 38 is set to be smaller than the maximum outer diameter D2 of the locking portion 38 (D1<D2).

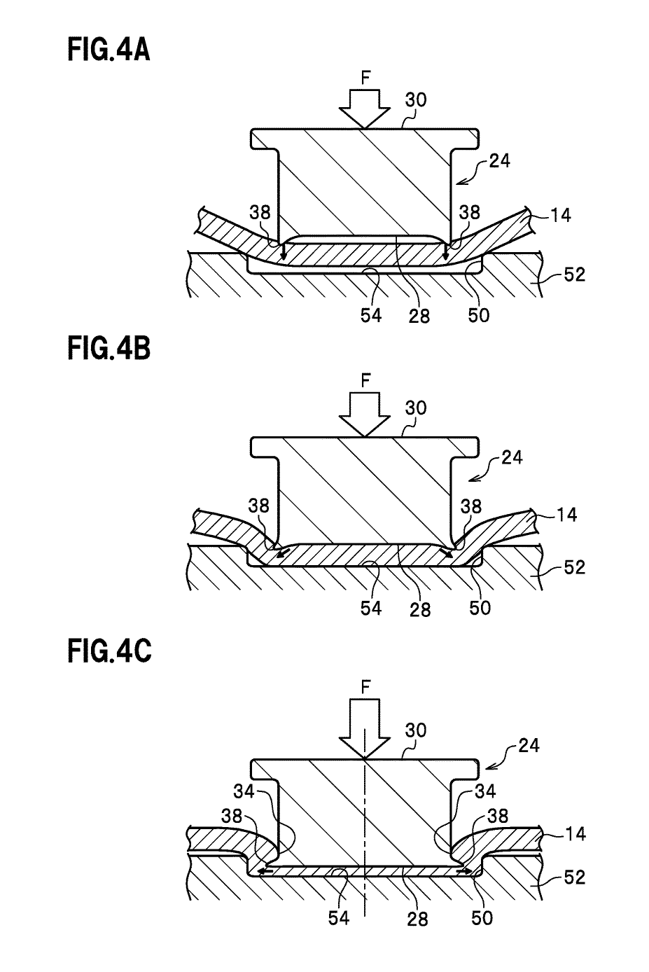

The vehicle body side port having the different material joining structure according to the present embodiment is basically constructed as described above. Next, advantageous effects of the structure will be described. FIGS. 4A to 4C are cross-sectional views of a fastening step in which the head portion of the rivet is calked to fasten the side outer panel, and FIGS. 5A to 5C are views of steps of a different material joining method according to the present embodiment.

In the assembly step of the vehicle 10, joining the first joint portion 22 and the second joint portion 26 on the vehicle body side by spot welding (resistance welding) will be described. Note that the first joint portion 22 and the second joint portion 26 are the same in that they are joined via the rivets 24, respectively. Therefore, the first joint portion 22 will be described, in which the roof side rail 12 including the two plates (side rail inner 16 and the side rail stiffener 18) is joined to the single side outer panel 14.

First of all, a step (see FIG. 5A) will be described, in which the locking portion 38 arranged on the head portion 28 of the rivet 24 is calked in a non-penetrating manner so as to fasten to the face of the side outer panel 14 which faces the roof side rail 12.

The single side outer panel 14 is set on a die 52 formed with a circular recess 50 recessed downward, and the head portion 28 of the rivet 24 is placed on the upper face of the side outer panel 14 to face the side outer panel 14 such that the rivet 24 is positioned above the recess 50 of the die 52. As shown in FIG. 4A, in such an arrangement, the rivet 24 is pressed from above with a predetermined pressing force F by a punch (not shown). This pressure force F makes, in the initial state, the locking portion 38 in a triangle shape having acute angles in cross-section is gradually pushed into the side outer panel 14 from top down (toward the die 52). Further, the side outer panel 14 is deformed along the recessed shape of the die 52.

Note that the inner diameter of the recess 50 in the die 52 is set to be larger than the outer diameters of the locking portion 38 of the rivet 24, the head portion 28 and the shaft 32. Further, the “initial state” indicates a state in which the side outer panel 14 pressed to be deformed is not in contact with an inner bottom face 54 of the recess 50 in the die 52.

Then, as shown in FIG. 4B, after the side outer panel 14 contacts (abuts on) the inner bottom face 54 of the recess 50 in the die 52, the side outer panel 14 which is deformed by the pressing force F from the punch (not shown) is forced to deform toward the direction (downward) pushed by the pressing force. However, the side outer panel 14 does not have a space to deform downward because the side outer panel 14 abuts on the inner bottom face 54, so that the side outer panel 14 is deformed outward (toward directions shown by arrows). At that time, the locking portion 38 of the rivet 24 is deformed to follow the outward deformation of the side outer panel 14.

As shown in FIG. 4C, the side outer panel 14 is deformed to be filled into the recess 50 of the die 52 by the pressing force from the punch, and the annular protrusion 34 is formed which protrudes inward so as to surround the locking portion 38 of the rivet 24 and the lower end of the shaft 32. Further, the locking portion 38 of the rivet 24 follows the outward deformation of the side outer panel 14, allowing the locking portion 38 to extend outward so as to be deformed to protrude radially outward whose direction is substantially orthogonal to the axis of the shaft 32.

After the fastening step is completed in which the rivet 24 is calked to the side outer panel 14 as shown in FIGS. 4A to 4C, the bottom portion 30 of the rivet 24 is brought into contact with the face of the roof side rail 12 which faces the side outer panel 14 (see FIG. 5B).

Finally, while the bottom portion 30 of the rivet 24 is maintained to contact the roof side rail 12, the roof side rail 12 is spot-welded to the side outer panel 14 in a state of having the rivet 24 therebetween (see FIG. 5C).

In other words, a predetermined current is flown through a pair of electrodes 56a, 56b facing to each other along the vertical direction in a state that the roof side rail 12 and the side outer panel 14 are respectively pressed and held by the electrodes 56a, 56b. In this way, the electrodes 56a, 56b are energized to form the nugget portion 36 as a joint between the roof side rail 12 and the bottom portion 30 of the rivet 24. The nugget portion 36 is formed largely over the two overlaid members of the side rail stiffener 18 and the side rail inner 16, and the rivet 24, to weld integrally and join the side rail stiffener 18, the side rail inner 16 and the bottom portion 30 of the rivet 24 firmly.

Note that, in the present embodiment, spot welding is used as an example of resistance welding, but, for example, seam welding may be used for joining.

In the present embodiment, the head portion 28 of the rivet 24 is calked in a non-penetrating manner to the side outer panel 14 in advance for mechanical fastening (FIG. 5A). Then, the side outer panel 14, the rivet 24, and the roof side rail 12 are overlaid from top down in that order between the pair of electrodes 56a, 56b to be used for resistance welding. The pair of electrodes 56a, 56b is energized for resistance welding in a state that the rivet 24 is disposed between the side outer panel 14 and the roof side rail 12. At that time, the side outer panel 14 has a higher electrical conductivity than that of the roof side rail 12, to make an electric resistance the highest between the rivet 24 and the roof side rail 12 having a low electrical conductivity, so as to generate heat to form the nugget portion 36 as the joint.

Therefore, in the present embodiment, the rivet 24 mechanically fastened to the side outer panel 14 can be firmly joined by resistance welding to the roof side rail 12 made of the same kind of metal material as the rivet 24. As a result, in the present embodiment, the side outer panel 14 is firmly joined to the roof side rail 12 via the rivet 24.

In the present embodiment, the rivet 24 does not need to penetrate as with the prior art disclosed in Patent Document 1, and can be used, for example, with the roof side rail 12 made of a high strength material, specifically, a high strength material made of iron having tensile strength of 980 MPa or more.

Further, in this embodiment, the rivet 24 is mechanically fastened to the side outer panel 14 and a through hole (prepared hole) is not formed in the side outer panel 14, because the through hole (prepared hole) is unnecessary. Accordingly, in the present embodiment, water does not enter through a prepared hole so that galvanic corrosion (electrochemical corrosion) can be prevented even without a separate sealing material. This reduces the manufacturing cost.

Still further, in the present embodiment, the rivet 24 can be mechanically fastened to the side outer panel 14 in advance, on a line separate from the vehicle body assembly line. Accordingly, the rivet 24 only has to be resistance welded to the roof side rail 12 on the vehicle body assembly line, which increases productivity and requires no new facility investment (for example, a structural adhesive coating device), so that the cost associated with facility investment is avoided.

Yet further, in the present embodiment, in the initial state where the rivet 24 is not joined to the side outer panel 14, the rivet 24 includes the locking portion 38 protruding in the axial direction from the peripheral edge of the head portion 28. In the state where the rivet 24 is pressed to fasten the side outer panel 14, the locking portion 38 is deformed to spread in the direction orthogonal to the axial direction of the head portion 28, to form the flat face by the head portion 28 and the locking portion 38 (see FIG. 4C). The joined face of the side outer panel 14 which faces the flat face formed by the head portion 28 and the locking portion 38 is also made flat. As a result, in the present embodiment, the current during resistance welding stably flows through the nugget portion 36 as a joint, allowing for forming the nugget portion 36 stably. In other words, the fastened faces (joined faces) of the rivet and the second panel are made flat, respectively, to form a stable power supply path from the electrodes during resistance welding, so that welding defects are avoided to secure the stable nugget portion 36.

Furthermore, in the present embodiment, the locking portion 38 is formed in a substantially triangular shape in cross-section by the first side 40, the second side 42 and the boundary line 44 (see FIG. 3B). When the rivet 24 is pressed to join to the side outer panel 14, the locking portion 38 is deformed to spread in the direction orthogonal to the axial direction of the head portion 28, to form the flat face by the head portion 28 and the locking portion 38.

Furthermore, in the present embodiment, the contact faces of the locking portion 38 of the rivet 24 and the side outer panel 14 are made flat, respectively, to form a stable power supply path from the electrodes during resistance welding, so that welding defects are avoided to secure the stable nugget portion 36.

Furthermore, in the present embodiment, the minimum inner diameter (D1) of the protrusion 34 is set to be smaller than the maximum outer diameter (D2) of the locking portion 38 (D1<D2), to allow for deforming the locking portion 38 while spreading it outward so s to join (fasten) the rivet 24 stably to the side outer panel 14. Note that, in FIG. 2, the relationship between the minimum inner diameter D1 and the maximum outer diameter D2 is conveniently illustrated, in which the rivet 24 is disposed between, and joined to, the roof side rail 12 and the side outer panel 14. The relationship is unchanged after the rivet 24 is calked and fastened to the side outer panel 14.

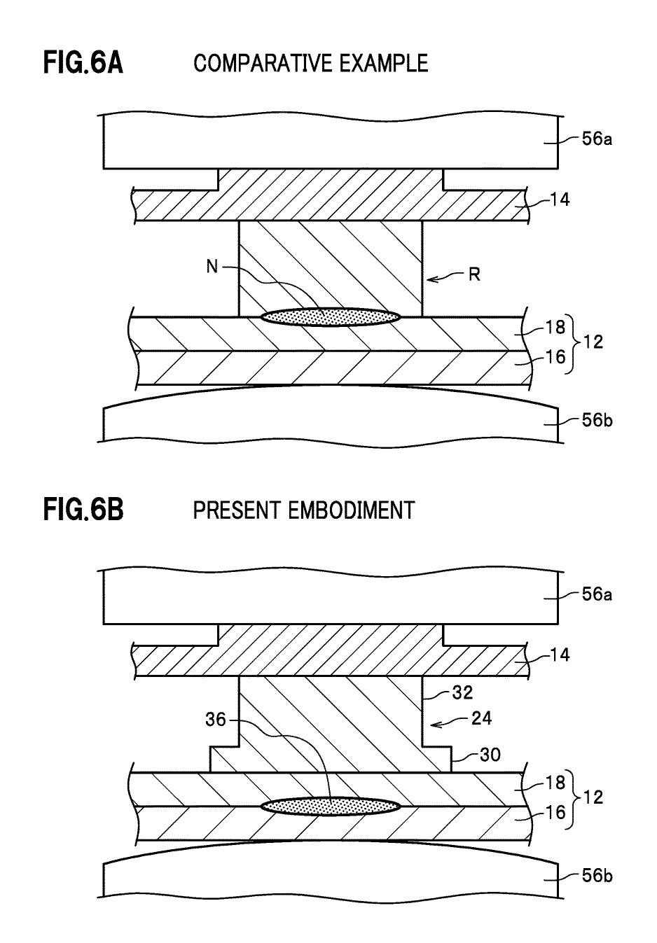

Furthermore, in the present embodiment, the bottom portion 30 constituting the rivet 24 has a larger diameter than the shaft 32, to allow for enlarging a contact area between the bottom portion 30 of the rivet 24 and the roof side rail 12 at the time of resistance welding (see FIG. 6B), as compared with the rivet R (see FIG. 6A) in the comparative example of the bottom portion and the shaft having the same diameters so as to have the same diameter as the shaft 32 of the rivet 24 according to the present embodiment. In addition, in the rivet R according to the comparative example, as shown in FIG. 6A, a nugget portion N is formed between the lower end face of the rivet R and the roof side rail 12. In contrast, in the present embodiment, the current density flowing during resistance welding is decreased, to allow the nugget portion 36 to be formed at a position closer to the side rail inner 16 and the side rail stiffener 18 constituting the roof side rail 12, as compared with the rivet R according to the comparative example. As a result, in the present embodiment, the rivet 24, and the side rail inner 16 and the side rail stiffener 18 constituting the roof side rail 12 are joined simultaneously.

Furthermore, in the present embodiment, spot welding requires relatively short time (takt) for welding among several kinds of resistance welding and has high welding stability, and therefore productivity is improved. Further, spot welding has been used conventionally on the common vehicle body assembly line, so that a new welding facility is not necessary and new facility investment is avoided.

FIG. 7A is an explanatory view of a case in which plating is applied on the external face of the rivet, FIG. 7B is an explanatory view of a case in which plating is applied on the external face of the roof side rail, and FIG. 7C is an explanatory view of a case in which plating is applied on the external faces of the rivet and the roof side rail.

Furthermore, in the present embodiment, plating P (see FIG. 7B) is applied on the external face of the roof side rail 12 to achieve antirust effect of the steel plates. If the rivet is made to penetrate the steel plates as in the prior art, the plated layer may be peeled off, which needs to be repaired, to reduce productivity. In the present embodiment, the plated layer (plating P) formed on the external face suffers under little influence from the rivet, allowing for improving productivity.

Furthermore, the plating P (see FIG. 7A) is applied on the external face of the rivet 24 to prevent galvanic corrosion, that is, rusting between the side outer panel 14 and the rivet 24 which are formed of different kinds of metals. Further, the rivet 24 is made of the same metal material as the roof side rail 12, to prevent deterioration of rust-prevention property due to contact between different kinds of metals. Note that, as shown in FIG. 7C, rust-prevention effect is further increased by applying the plating P on the respective external faces of the rivet 24 and the roof side rail 12.

Furthermore, in the present embodiment, the side outer panel 14 which is a larger-sized part than other body parts can be made of aluminum, an aluminum alloy, magnesium or the like having a higher conductivity than that of iron, leading to weight reduction of the vehicle body. Still further, the roof side rails 12 as vehicle body frame members can be formed of a high-tensile steel plate, leading to high strength and weight reduction of the vehicle body.

### DESCRIPTION OF REFERENCE NUMERALS

10 vehicle body 12 roof side rail (first panel) 14 side outer panel (second panel) 24 rivet (rivet for joining different materials) 28 head portion 30 bottom portion 32 shaft 34 protrusion 36 nugget portion 38 locking portion 40 first side 42 second side 44 boundary line P plating

1. A different material joining structure comprising:
a first panel made of a first metal material;
a second panel made of a second metal material that has a higher conductivity than that of the first panel, is different from the first metal material, and at least a part of which faces the first panel; and
a rivet for joining the first panel and the second panel,
wherein the rivet is made of the first material, and includes a head portion that is embedded in the second panel in a non-penetrating manner and a bottom portion that abuts on the first panel, and
wherein a nugget portion as a joint portion is disposed between the first panel and the bottom portion, the nugget portion being formed by resistance welding the rivet to the first portion with the rivet disposed between the first panel and the second panel.

2. The different material joining structure according to claim 1,
wherein, before the head portion is embedded in the second panel, the rivet includes a locking portion that protrudes in an axial direction from a peripheral edge of the head portion and is pressed on the second panel to spread in a direction orthogonal to the axial direction so as to be locked in the second panel, and
after the head portion is embedded in the second panel, the locking portion is made flush with the head portion.

3. The different material joining structure according to claim 2,
wherein, before the head portion is embedded in the second panel, the locking portion includes: a first side that extends from an outer peripheral face of a shaft arranged between the head portion and the bottom portion in the axial direction; and a second side that extends radially to incline downward from an extended end of the first side toward the head portion in the axial direction, and
wherein the locking portion is formed in a substantially triangular shape in cross-section by the first side, the second side and a boundary line between the locking portion and the head portion.

4. The different material joining structure according to claim 2,
wherein, after the locking portion is embedded in the second panel, respective contact faces of the second panel and the locking portion are made flat.

5. The different material joining structure according to claim 2,
wherein the second panel includes an annular protrusion formed by pressing the rivet to the second panel, and
wherein, after the locking portion is embedded in the second panel, the minimum inner diameter of the protrusion is set to be smaller than the maximum outer diameter of the locking portion.

6. The different material joining structure according to claim 3,
wherein the first panel includes plate members and an outer diameter of the bottom portion is set to be larger than an outer diameter of the shaft.

7. The different material joining structure according to claim 1,
wherein the resistance welding is spot welding.

8. The different material joining structure according to claim 1,
wherein plating is applied on an external face of the first panel.

9. The different material joining structure according to claim 1,
wherein plating is applied on an external face of the rivet.

10. The different material joining structure according to claim 1,
wherein a vehicle includes a pair of right and left roof side rails that extends in a longitudinal direction of the vehicle at upper vehicle body sides, and a pair of right and left side outer panels that covers vehicle outer sides of the respective roof side rails to form design faces of the vehicle body sides,
wherein each roof side rail is formed of the first panel, and
wherein each side outer panel is formed of the second panel.

11. A different material joining method for joining a first panel that is made of a first metal material to a second panel that has a higher conductivity than that of the first panel, is made of a second metal material different from the first metal material, and at least a part of which faces the first panel, comprising steps of:
embedding a head portion of the rivet in the second panel in a non-penetrating manner;
abutting a bottom portion of the rivet on the first panel; and
forming a nugget portion as a joint portion between the first panel and the bottom portion by resistance welding the rivet to the first portion with the rivet disposed between the first panel and the second panel.
